(19) United States
(12) Patent Application Publication
(10) Pub. No.: US 2024/0040442 A1
(43) Pub. Date: Feb. 1, 2024

(54) CELL PREPARATION

(71) Applicant: Nokia Solutions and Networks Oy, Espoo (FI)

(72) Inventors: Krzysztof KORDYBACH, Wroclaw (PL); Ahmad AWADA, Munich (DE); Srinivasan SELVAGANAPATHY, Bangalore (IN); Subramanya CHANDRASHEKAR, Bangalore (IN); Jedrzej STANCZAK, Wroclaw (PL)

(21) Appl. No.: 18/258,505

(22) PCT Filed: Jan. 10, 2022
(86) PCT No.: PCT/EP2022/050300

§ 371 Date: Jun. 20, 2023

(30) Foreign Application Priority Data
Jan. 20, 2021 (GB) 2100736.4

(51) Int. Cl. H04W 36/00

(52) U.S. Cl. CPC H04W 36/0016; H04W 36/008357

(57) ABSTRACT

A network node comprising at least one processor; and at least one memory including computer program code; the at least one memory and the computer program code configured to, with the at least one processor, cause the apparatus at least to perform: transmitting a request to a plurality of nodes to prepare one or more cell candidates; receiving an indication from at least one of the plurality of nodes indicating a capacity to prepare one or more further cell candidates; and transmitting, to one or more of the at least one of the plurality of nodes, a further request to prepare at least one further cell candidate.

### TECHNOLOGICAL FIELD

Embodiments of the present disclosure relate to cell preparation. Some relate to cell preparation in conditional PSCell change (CPC).

### BACKGROUND

A wireless network comprises a plurality of network nodes including terminal nodes and access nodes. Communication between the terminal nodes and the access nodes is wireless.

In some circumstances, it may be desirable to modify or enhance cell preparation in the wireless network.

### BRIEF SUMMARY

According to various, but not necessarily all, embodiments there is provided a network node comprising means for:
transmitting a request to a plurality of nodes to prepare one or more cell candidates;
receiving an indication from at least one of the plurality of nodes indicating a capacity to prepare one or more further cell candidates; and
transmitting, to one or more of the at least one of the plurality of nodes, a further request to prepare at least one further cell candidate.

In some examples, the request indicates a maximum number of cell candidates.

In some examples, the indication comprises at least one flag.

In some examples, the indication comprises a value representing the number of cell candidates a node has the capacity to prepare above the requested number of cell candidates.

In some examples, the indication comprises a list of the one or more cell candidates that can be prepared above the requested number of cell candidates.

In some examples the means is configured to:
determine, based at least in part on the indication, the one or more of the at least one of the plurality of nodes to which the further request is to be transmitted; and/or
transmit the indication to a network node to enable a determination of the one or more of the at least one of the plurality of nodes to which the further request is to be transmitted.

In some examples, the list of cell candidates comprises a corresponding measurement for the one or more cell candidates in the list.

In some examples, the list of cell candidates comprises an associated weight for the one or more cell candidates in the list, the associated weight indicating a comparison with one or more prepared cell candidates.

In some examples, the associated weight provides an indication of one or more radio properties for the one or more cell candidates in the list and/or priority of the one or more cell candidates in the list.

In some examples, the means is configured to:
receive, from at least one of the plurality of nodes, an indication that at least one additional cell candidate above the requested number of cell candidates has been prepared; and
transmit, to one or more of the at least one of the plurality of nodes from which an indication that at least one additional cell candidate has been prepared, a confirmation that one or more of the at least one additional cell candidate should be maintained, wherein the transmitting is prior to expiry of a timer.

In some examples, the means is configured to:
receive an indication from at least one of the plurality of nodes indicating that the requested number of cell candidates cannot be prepared.

In some examples, the means is configured to:
amend a number of cell candidates to be prepared by at least one node based, at least in part, on the received indication from at least one of the plurality of nodes indicating a capacity to prepare one or more further cell candidates.

In some examples, the means is configured to:
transmit a reconfiguration message to a terminal node when an overall maximum number of cell candidates has been prepared.

In some examples, the means comprises
at least one processor; and
at least one memory including computer program code, the at least one memory and computer program code configured to, with the at least one processor, cause the performance of the apparatus.

According to various, but not necessarily all, embodiments there is provided a method comprising:
transmitting a request to a plurality of nodes to prepare one or more cell candidates;
receiving an indication from at least one of the plurality of nodes indicating a capacity to prepare one or more further cell candidates; and
transmitting, to one or more of the at least one of the plurality of nodes, a further request to prepare at least one further cell candidate.

In some examples, the request indicates a maximum number of cell candidates.

In some examples, the indication comprises at least one flag.

In some examples, the indication comprises a value representing the number of cell candidates a node has the capacity to prepare above the requested number of cell candidates.

In some examples, the indication comprises a list of the one or more cell candidates that can be prepared above the requested number of cell candidates.

In some examples, the method comprises:
determining, based at least in part on the indication, the one or more of the at least one of the plurality of nodes to which the further request is to be transmitted; and/or
transmitting the indication to a network node to enable a determination of the at least one of the plurality of nodes to which the further request is to be transmitted.

In some examples, the list of cell candidates comprises a corresponding measurement for the one or more cell candidates in the list.

In some examples, the list of cell candidates comprises an associated weight for the one or more cell candidates in the list, the associated weight indicating a comparison with one or more prepared cell candidates.

In some examples, the associated weight provides an indication of one or more radio properties for the one or more cell candidates in the list and/or priority of the one or more cell candidates in the list.

In some examples, the method comprises:
receiving, from at least one of the plurality of nodes, an indication that at least one additional cell candidate above the requested number of cell candidates has been prepared; and
transmitting, to one or more of the at least one of the plurality of nodes from which an indication that at least one additional cell candidate has been prepared, a confirmation that one or more of the at least one additional cell candidate should be maintained, wherein the transmitting is prior to expiry of a timer.

In some examples, the method comprises:
receiving an indication from at least one of the plurality of nodes indicating that the requested number of cell candidates cannot be prepared.

In some examples, the method comprises:
amending a number of cell candidates to be prepared by at least one node based, at least in part, on the received indication from at least one of the plurality of nodes indicating a capacity to prepare one or more further cell candidates.

In some examples, the method comprises:
transmitting a reconfiguration message to a terminal node when an overall maximum number of cell candidates has been prepared.

According to various, but not necessarily all, embodiments there is provided a computer program comprising instructions for causing an apparatus to perform at least the following:
transmitting a request to a plurality of nodes to prepare one or more cell candidates;
receiving an indication from at least one of the plurality of nodes indicating a capacity to prepare one or more further cell candidates; and
transmitting, to one or more of the at least one of the plurality of nodes, a further request to prepare at least one further cell candidate.

In some examples, the request indicates a maximum number of cell candidates.

In some examples, the indication comprises at least one flag.

In some examples, the indication comprises a value representing the number of cell candidates a node has the capacity to prepare above the requested number of cell candidates.

In some examples, the indication comprises a list of the one or more cell candidates that can be prepared above the requested number of cell candidates.

In some examples, the computer program comprises instructions for causing the apparatus to perform:
determining, based at least in part on the indication, the one or more of the at least one of the plurality of nodes to which the further request is to be transmitted; and/or
transmitting the indication to a network node to enable a determination of the at least one of the plurality of nodes to which the further request is to be transmitted.

In some examples, the list of cell candidates comprises a corresponding measurement for the one or more cell candidates in the list.

In some examples, the list of cell candidates comprises an associated weight for the one or more cell candidates in the list, the associated weight indicating a comparison with one or more prepared cell candidates.

In some examples, the associated weight provides an indication of one or more radio properties for the one or more cell candidates in the list and/or priority of the one or more cell candidates in the list.

In some examples, the computer program comprises instructions for causing the apparatus to perform:
receiving, from at least one of the plurality of nodes, an indication that at least one additional cell candidate above the requested number of cell candidates has been prepared; and
transmitting, to one or more of the at least one of the plurality of nodes from which an indication that at least one additional cell candidate has been prepared, a confirmation that one or more of the at least one additional cell candidate should be maintained, wherein the transmitting is prior to expiry of a timer.

In some examples, the computer program comprises instructions for causing the apparatus to perform:
receiving an indication from at least one of the plurality of nodes indicating that the requested number of cell candidates cannot be prepared.

In some examples, the computer program comprises instructions for causing the apparatus to perform:
amending a number of cell candidates to be prepared by at least one node based, at least in part, on the received indication from at least one of the plurality of nodes indicating a capacity to prepare one or more further cell candidates.

In some examples, the computer program comprises instructions for causing the apparatus to perform:
transmitting a reconfiguration message to a terminal node when an overall maximum number of cell candidates has been prepared.

According to various, but not necessarily all, embodiments there is provided a network node comprising means for:
receiving a request to prepare one or more cell candidates;
determining a capacity to prepare one or more further cell candidates;
transmitting an indication indicating a capacity to prepare one or more further cell candidates; and
receiving a further request to prepare at least one further cell candidate.

In some examples, the request indicates a maximum number of cell candidates.

In some examples, the means are configured to prepare at least one further cell candidate based, at least in part, on the received further request.

In some examples, the means is configured to:
prepare at least one additional cell candidate above the requested number of cell candidates;
transmit an indication that at least one additional cell candidate above the requested number of cell candidates has been prepared;
determine whether a confirmation that the at least one additional cell candidate should be maintained has been received prior to expiry of a timer;
if it is determined that a confirmation has been received prior to expiry of the timer, maintaining the at least one additional cell candidate; and
if it is determined that a confirmation has not been received prior to expiry of the timer, releasing the at least one additional cell candidate.

In some examples, the means comprises
at least one processor; and
at least one memory including computer program code, the at least one memory and computer program code configured to, with the at least one processor, cause the performance of the apparatus.

According to various, but not necessarily all, embodiments there is provided a network node comprising means for:
receive an indication indicating a capacity for at least one node to prepare one or more further cell candidates;
determining based, at least in part, on the received indication, one or more nodes that are to be requested to prepare one or more further cell candidates; and
transmitting one or more signals to cause the determined one or more nodes to prepare one or more further cell candidates.

According to various, but not necessarily all, embodiments there is provided a network node comprising means for:
transmitting a request to a plurality of nodes to prepare one or more cell candidates; and
receiving an indication from at least one of the plurality of nodes indicating a capacity to prepare one or more further cell candidates.

In some examples, the means comprises
at least one processor; and
at least one memory including computer program code, the at least one memory and computer program code configured to, with the at least one processor, cause the performance of the apparatus.

According to various, but not necessarily all, embodiments there is provided an apparatus comprising means for performing at least part of one or more methods disclosed herein.

According to various, but not necessarily all, embodiments there is provided an apparatus comprising
at least one processor; and
at least one memory including computer program code;
the at least one memory and the computer program code configured to, with the at least one processor, cause the apparatus at least to perform at least a part of one or more methods disclosed herein.

According to various, but not necessarily all, embodiments there is provided examples as claimed in the appended claims.

The description of a function and/or action should additionally be considered to also disclose any means suitable for performing that function and/or action.

### BRIEF DESCRIPTION

Some examples will now be described with reference to the accompanying drawings in which:

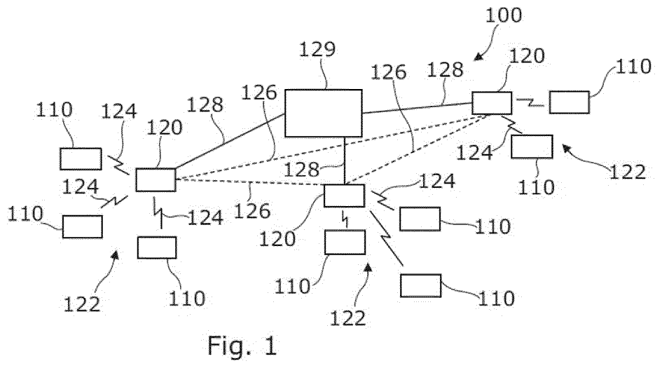

FIG. 1 shows an example of the subject matter described herein;

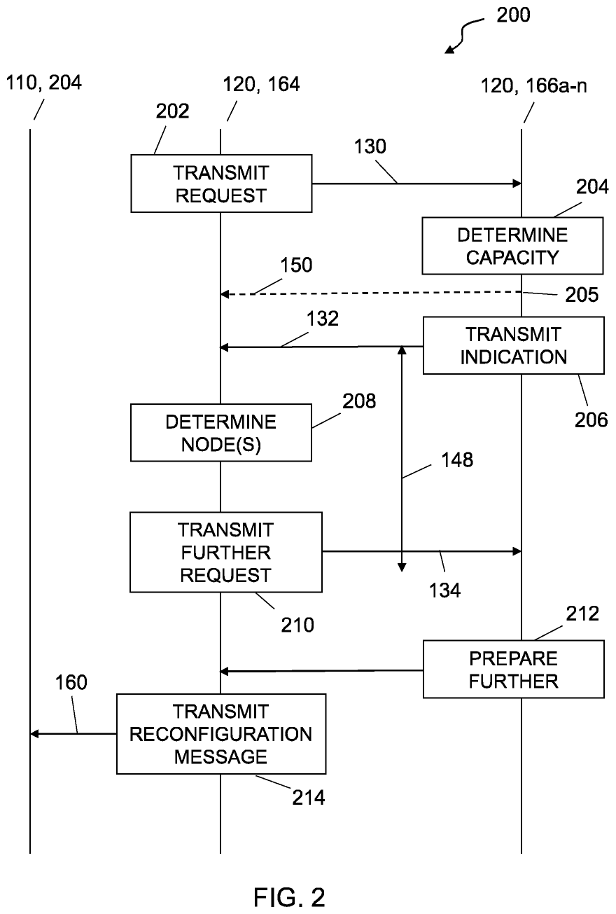

FIG. 2 shows another example of the subject matter described herein;

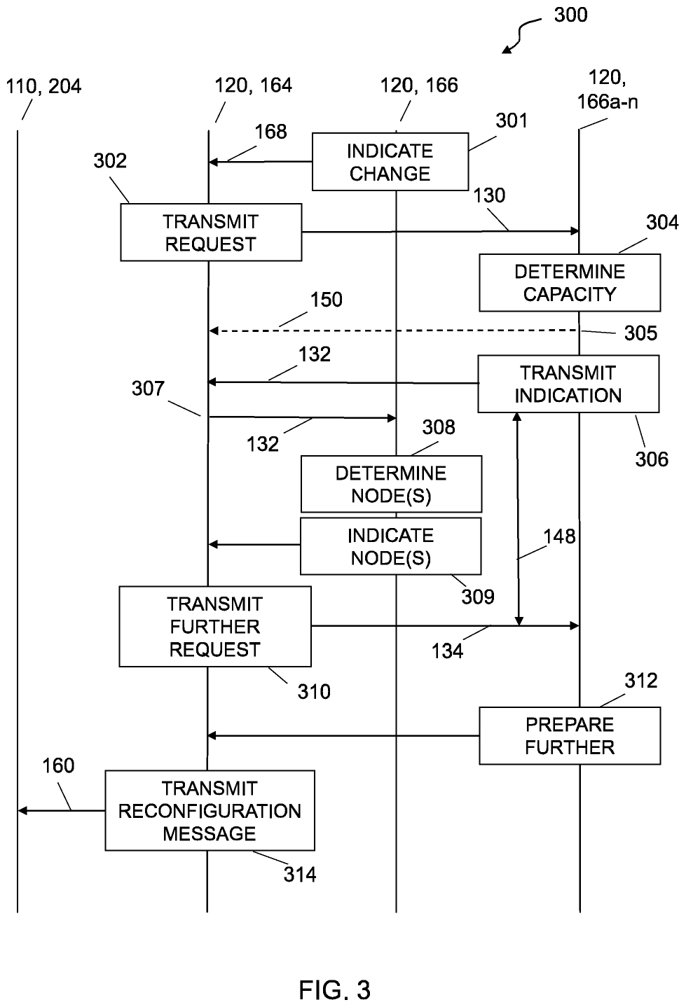

FIG. 3 shows another example of the subject matter described herein;

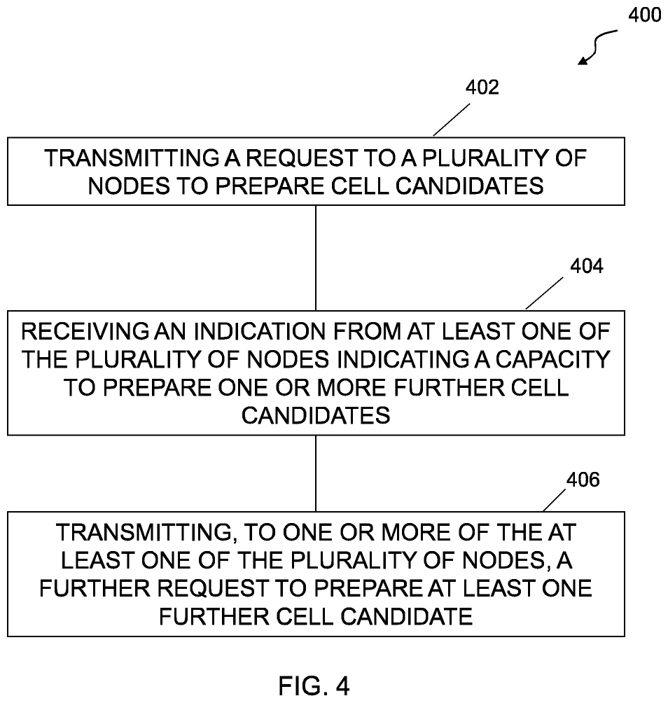

FIG. 4 shows another example of the subject matter described herein;

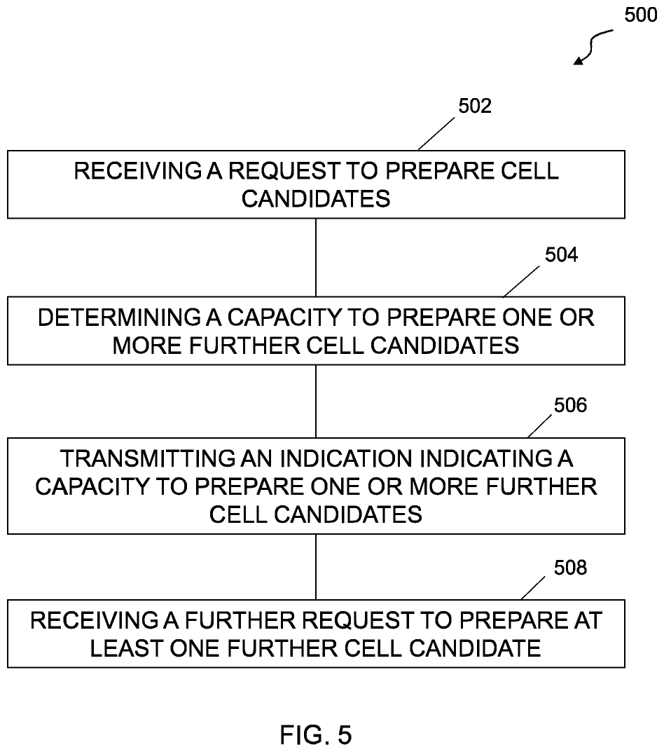

FIG. 5 shows another example of the subject matter described herein;

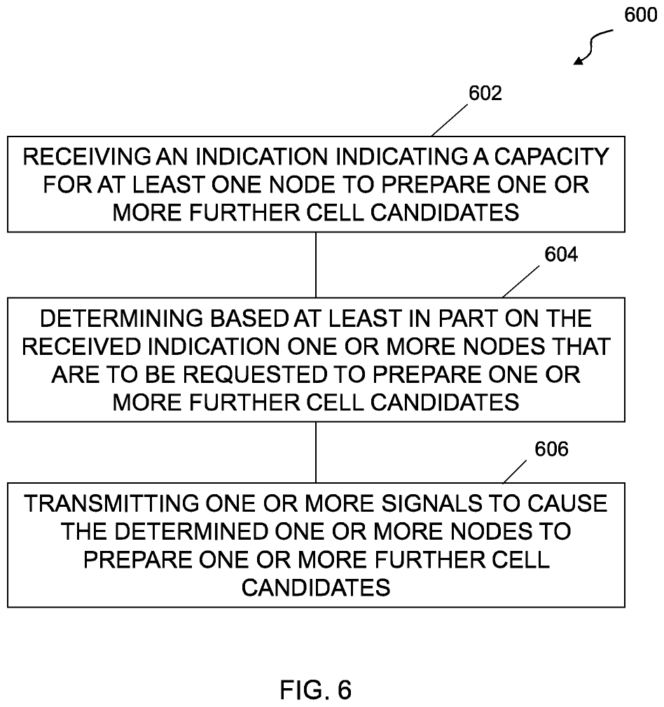

FIG. 6 shows another example of the subject matter described herein;

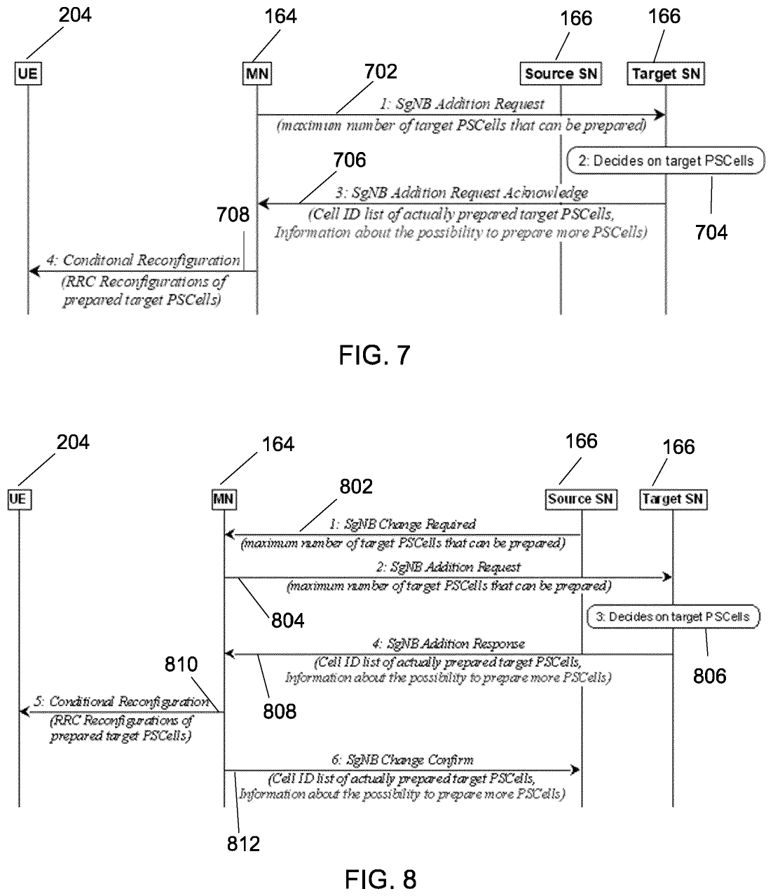

FIG. 7 shows another example of the subject matter described herein;

FIG. 8 shows another example of the subject matter described herein;

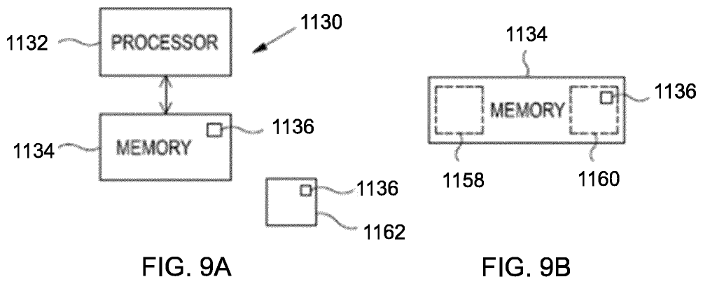

FIG. 9A shows another example of the subject matter described herein; and

FIG. 9B shows another example of the subject matter described herein.

### DEFINITIONS

Master node (MN): Network node that provides control plane connectivity towards the core network.

Secondary Node (SN): Network node that is providing additional radio resources for the UE but is not the MN.

Master Cell Group (MCG): Group of cells associated with the MN, includes PCell.

Secondary Cell Group (SCG): Group of cells associated with the SN, includes PSCell.

PCell: the cell for uplink/downlink connection to MN. Cell of MCG used to initiate initial access to the MN.

PSCell: the cell for uplink/downlink connection to SN. Cell of SCG used to initiate initial access to the SN.

Dual Connectivity (DC):

UE has contemporaneous connection to an MN and an SN. This is a mode of operation of a UE in RRC_CONNECTED, configured with a Master Cell Group and a Secondary Cell Group.

Configuration Information:

Information used to configure operation of a UE. In 3GPP, the configuration information can, for example, be provided in an RRCReconfiguration message.

The term “configuration information comprising” and entity (for example handover execution condition for a primary cell; addition condition for dual connectivity with the primary cell and so on) can mean that the configuration information comprises information sufficient to obtain the entity. It may or may not comprise all parameters of the entity, it may instead comprise pointer to the entity or parameters of the entity or can mean that configuration includes the entity.

Dual Connectivity (DC) Configuration Information

Configuration information for dual connectivity to a primary secondary cell (PSCell). The DC configuration information can be/comprise condition DC configuration information comprising an addition condition for a primary secondary cell for dual connectivity with the primary cell and a measurement configuration for configuring measurements for an addition condition for the primary secondary cell for dual connectivity with the primary cell, that is, dual connectivity of the UE with both the primary cell and the primary secondary cell.

Triggering addition of a primary secondary cell for dual connectivity is dependent upon the measurements meeting the addition condition for the primary secondary cell.

In 3GPP, a RRCReconfiguration message specifies a ConditionalReconfiguration information element which provides addition or change conditions for the DC. The ConditionalReconfiguration information element comprises a CondReconfigToAddModList information element. The CondReconfigToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.

Conditional PSCell Change (CPC): A change of PSCell procedure that is executed by the UE when the configured execution condition(s) are met for a candidate cell. Condition(s) pre-configured by network.

Conditional PSCell Change (CPC) configuration information: Configuration information for change of PSCell. The CPC configuration information can comprise one or more change execution conditions for one or more PSCells and one or more measurement configurations for configuring measurements for PSCell change. Triggering conditional PSCell change is dependent upon the measurements meeting the change execution condition(s) for a candidate cell.

Conditional PSCell Addition (CPA): An addition of PSCell procedure that is executed by the UE when the execution condition(s) are met for a candidate cell. Condition(s) pre-configured by network.

Conditional PSCell Addition (CPA) configuration information: Configuration information for addition of PSCell. The CPA configuration information can comprise one or more addition execution conditions for one or more PSCells and one or more measurement configurations for configuring measurements for PSCell addition. Triggering conditional PSCell addition is dependent upon the measurements meeting the addition execution condition(s) for a candidate cell.

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a telecommunications network, in which at least some of the terminal nodes 110 and access nodes 120 communicate with each other using transmission/reception of radio waves/signals.

The one or more core nodes 129 may, in some examples, communicate with each other. The one or more access nodes 120 may, in some examples, communicate with each other.

The one or more terminal nodes 110 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node(s) 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations (for example, gNBs).

Functionality of a base station may be distributed between a central unit (CU), for example a gNB-CU, and one or more distributed units (DU), for example gNB-DUs.

In the particular example illustrated the network 100 is an Evolved Universal Terrestrial Radio Access network (E-UTRAN). The E-UTRAN consists of E-UTRAN NodeBs (eNBs), providing the E-UTRA user plane and control plane (for example, RRC) protocol terminations towards the UE. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs), providing the user plane and control plane (for example, RRC) protocol terminations towards the UE. The gNBs are interconnected with each other by means of an X2/Xn interface 126. The gNBs are also connected by means of the N2 interface 128 to the Access and Mobility management Function (AMF).

In examples, the network 100 can comprise a combination of E-UTRAN and NG-RAN.

An access node 120, such as a gNB, can configure a terminal node 110, such as a UE, to perform a conditional cell change and/or a conditional cell addition.

In examples, an access node 120 can configure a terminal node 110 to perform conditional PSCell change (CPC) and/or conditional PSCell addition (CPA).

A terminal node 110 can be provided with CPC configuration information and/or CPA configuration information and can evaluate the execution condition(s) for candidate cells, such as candidate PSCells, and execute cell change and/or addition upon the execution condition(s) for a candidate cell being met.

Accordingly, in some examples, a terminal node 110 can evaluate execution condition(s) for candidate PSCells and execute PSCell change and/or addition upon the execution condition(s) for a candidate PSCell being met.

In order to enable conditional cell change and/or addition, such as CPC and/or CPA, one or more network nodes, such as one or more target secondary nodes (SN) 166, prepares cell candidates ready for potential use by a terminal node 110 when execution condition(s) for a cell candidate are met. Cell candidates can be target PSCell candidates.

In examples, preparing cell candidates comprises allocating resources needed for a terminal node's signaling and data radio bearers. The terminal node 110 can also be allocated a Random Access Channel (RACH) preamble in case of contention free RACH access to a target node.

Some examples relate to a 3GPP network.

FIG. 2 illustrates an example of a method 200.

In examples, FIG. 2 can be considered to illustrate a plurality of methods. For example, FIG. 2 illustrates one or more actions at a plurality of actors/entities. In examples, FIG. 2 can be considered to illustrate a plurality of methods performed by the individual actors/entities.

One or more of the features discussed in relation to FIG. 2 can be found in one or more of the other figures.

In the example of FIG. 2, a plurality of apparatuses transmit and/or receive one or more signals and/or one or more messages across and/or via and/or using a network. In examples, any suitable form of communication in any suitable network can be used. For example, at least a portion of the network 100 of FIG. 1 can be used.

Accordingly, in examples, the plurality of apparatuses in FIG. 2 form at least a portion of a network 100 as described in relation to FIG. 1.

In the illustrated example, a terminal node 110, such as a UE 204, and a plurality of access nodes 120, such as gNBs, transmit and/or receive one or more signals and/or one or more messages.

However, in examples any suitable nodes can be used.

In the example of FIG. 2, the access nodes comprise a master node (MN) 164 and a plurality of secondary nodes (SN) 166a-n are included. The plurality of SNs 166a-n do not have a radio connection with the terminal node 110 and are therefore target SNs 166 a-n.

In the illustrated example, for the sake of clarity, a single line is used to represent the plurality of target SNs 166a-n.

In examples, communications and/or transmissions between elements illustrated in FIG. 2 can proceed via any number of intervening elements, including no intervening elements.

In examples, any suitable number of network nodes can be included. For example, a plurality of terminal nodes 110 can be included.

Additionally, or alternatively, in examples the terminal node 110 can be connected to a source SN 166 (not illustrated in FIG. 2).

In examples, the method 200 and/or parts of the method 200 can be considered a method of preparing cell candidates and/or a method of coordinating cell candidate preparation.

In some examples, method 200 can be considered to form at least part of a CPC or CPA procedure.

At block 202 the method 200 comprises transmitting a request 130 to a plurality of nodes to prepare one or more cell candidates.

In the example of FIG. 2, the plurality of nodes are target secondary nodes 166a-n. However, any suitable type of nodes can be used.

In the illustrated example, the location of the blocks indicates the entity performing the action(s). For example, in FIG. 2, block 202 is performed at and/or by the access node 120 that is the MN 164.

As FIG. 2 illustrates one or more actions of transmission, FIG. 2 also illustrates the corresponding receiving feature(s)/action(s) and vice versa.

For example, from the point of view of the access nodes 120, that in the example of FIG. 2 are target SNs 166a-n, block 202 can be considered to illustrate receiving a request 130 to prepare cell candidates.

This is illustrated by the arrow from block 202 pointing to the line representing the target SNs 166a-n in the example of FIG. 2.

In examples, the request 130 can have any suitable form and/or be transmitted in any suitable way.

For example, the request 130 can have any suitable form to request preparation of one or more cell candidates.

In some examples, an amount of cell candidates, such as a maximum amount of cell candidates that a node should prepare, can be predefined. For example, a node that receives request 130 can already be configured with and/or can know and/or can access and/or can determine a predefined amount of cell candidates to be prepared.

In examples, it can be predefined that upon and/or in response to receiving a request 130, a node, such as a target SN 166, should prepare a predetermined number of cell candidates.

Any suitable predetermined number of cell candidates can be used. For example, the predetermined number can be 1, 2, 3 and so on.

In examples, a predetermined number of cell candidates can be considered a predetermined maximum number of cell candidates.

In some examples, a request 130 provides no explicit indication of a number of cell candidates and a node receiving the request 130 can consider such a request 130 to be a request to prepare a predetermined number of cell candidates.

In examples, a procedure involving cell candidate preparation, such as a CPC or CPA procedure, can have an overall and/or global and/or total number of prepared cell candidates.

Accordingly, in some examples, a request 130 can be sent to an appropriate number of nodes with regard to a predetermined number of cell candidates to be prepared upon and/or in response to receiving the request 130, and the overall and/or global and/or total number of prepared cell candidates for a procedure.

For example, if it is predefined that a node should prepare one cell candidate upon and/or in response to receiving a request 130 and the limit for the procedure is 8 cell candidates, a request 130 can be sent to 8 different nodes.

In some examples, the request 130 indicates a maximum number of cell candidates.

In examples, the request 130 can be considered to indicate a maximum number of cell candidates to be prepared by a node that receives the request 130.

In some examples a maximum number of cell candidates to be prepared by a node 130 can be considered a local maximum. In examples, a local maximum number of cell candidates is less than or equal to a global maximum of cell candidates.

The request 130 can have any suitable form to indicate a maximum number of cell candidates to be prepared.

In some examples, the request 130 comprises a numerical value and/or reference to a numerical value to indicate the maximum number of cell candidates.

In examples, the request 130 transmitted to different nodes can be the same or different. For example, the form of the request 130 for different nodes can the same of different.

In some examples, the maximum number of cell candidates for different nodes can be the same or different.

Accordingly, in some examples the requests 130 sent to different ones of the plurality of target SNs 166a-n can indicate different numbers of maximum cell candidates.

For example, a request 130 transmitted to a first target SN 166a can indicate a maximum of 3 cell candidates and a request sent to a second, different target SN 166b can indicate a maximum of 2 cell candidates and so on.

In examples, a request 130 can be considered a request 130 to prepare a requested number of cell candidates.

In some examples, the requested number of cell candidates can be implicit. For example, the requested number of cell candidates to be prepared upon and/or in response to receiving the request 130 can be predetermined and therefore the request 130 does not explicitly indicate an amount of cell candidates to be prepared.

In some examples, the requested number of cell candidates can be explicit. For example, the requested number of cell candidates to be prepared can be explicitly indicated in some way in the request 130.

In examples, any suitable type and/or form of cell candidates can be used. For example, the cell candidates can be target PSCells.

In some examples, the request 130 comprises a SgNB Addition Request message, including an indication of the maximum number of target PSCells that can be prepared.

In examples, an indication of the maximum number of cell candidates can be considered a limit indication and/or a maximum indication and so on.

At block 204, the method 200 comprises determining a capacity to prepare one or more further cell candidates.

In the example of FIG. 2 block 204 is performed by the plurality of access nodes 120 to which the request 130 is sent. In the illustrated example, the plurality of access nodes 120 are the target SNs 166a-n.

Accordingly, in examples, block 204 is performed separately by each of the plurality of access nodes 120 to which the request 130 is sent.

In some examples, determining a capacity to prepare one or more further cell candidates can be considered determining a capacity of a node to prepare one or more further cell candidates above and/or beyond and/or in addition to the requested number of cell candidates.

The requested number of cell candidates can be implicit, for example where a request does not indicate a number of cell candidates and a predetermined number of cell candidates is used, or explicit, for example where the request 130 indicates a number and/or a maximum number of cell candidates.

In examples, determining a capacity to prepare one or more further cell candidates can be considered determining a capacity of a node to prepare one or more further cell candidates above and/or beyond and/or in addition to the maximum number of cell candidates indicated in the request 130.

For example, a maximum number of cell candidates explicitly indicated in a request 130 can be considered a requested number of cell candidates.

As used herein, the term “determining” (and grammatical variants thereof) can include, not least: calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

Any suitable method for determining a capacity to prepare one or more further cell candidates can be used. For example, any suitable information can be used in determining a capacity to prepare one or more further cell candidates.

In examples, determining a capacity to prepare one or more further cell candidates comprises preparing the requested number of cell candidates indicated by and/or in the request 130 and considering remaining resources and/or load at the node, such as an access node 120 which can be a target SN 166a-n.

In some examples, determining a capacity to prepare one or more further cell candidates comprises preparing the maximum number of cell candidates indicated in the request 130 and considering remaining resources and/or load at the node, such as an access node 120 which can be a target SN 166a-n.

In examples, a target SN 166 analyzes measurements made by the terminal node 110 and forwarded to the target SN 166 in the request 130. The target SN 166 can then formulate a list of candidate cells, such as candidate PSCells, that can offer acceptable connection quality for the terminal node 110.

The list can be longer that the limit and hence the target SN determined that it has capacity to prepare one or more further cell candidates.

In some examples, the list can be shorter than the limit. For example, if, according to the measurements, there are no more cells that can serve the UE and/or some of the suitable target cells do not have resources available. For example, physical resources and/or configuration to serve a given service.

In examples, preparing cell candidates comprises allocating resources needed for a terminal node's signaling and data radio bearers. The terminal node 110 can also be allocated a Random Access Channel (RACH) preamble in case of contention free RACH access to a target node.

In some examples, it is determined by an access node 120, such as one or more of the plurality of target SNs 166a-n in the example of FIG. 2, that the requested number of cell candidates indicated for that node cannot be prepared.

For example, it can be determined, by an access node 120, that the indicated maximum number of cell candidates indicated for that node cannot be prepared.

In such examples, an access node 120 can transmit an indication 150 that the requested number of cell candidates cannot be prepared. For example, an access node 120 can transmit an indication 150 that the requested number of cell candidates cannot be prepared.

This is illustrated at block 205 of FIG. 2 by the dashed arrow pointing from the target SNs 166a-n towards the MN 164.

At block 205, the method 200 comprises, from the point of view of a target SN 166, transmitting an indication 150 indicating that the requested number of cell candidates cannot be prepared.

In examples, block 205 can be considered to illustrate transmitting an indication 150 indicating that the maximum number of cell candidates cannot be prepared.

From the point of view of the MN 164, block 205 comprises receiving an indication 150 from at least one of the plurality of nodes indicating that the requested number of cell candidates cannot be prepared.

In examples, block 205 can be considered to illustrate receiving an indication 150 from at least one of the plurality of nodes indicating that the maximum number of cell candidates cannot be prepared.

Any suitable indication 150, having any suitable form, can be used to indicate that the requested number of cell candidates cannot be prepared. For example, a flag and/or a numerical value and/or a reference to a numerical value and/or a list of candidate cells prepared and so on can be used.

In examples an indication 150 that the requested number of cell candidates cannot be prepared can be considered an under-limit indication and/or preparation capacity failure indication and so on.

In some examples, it is determined by an access node 120, such as one or more of the plurality of target SNs 166a-n in the example of FIG. 2, that the node has capacity to prepare more cell candidates than the amount indicated for that node.

At block 206, the method 200 comprises transmitting an indication 132 indicating a capacity to prepare one or more further cell candidates.

In examples, transmitting an indication 132 indicating a capacity to prepare one or more further cell candidates can be considered transmitting an indication 132 indicating a capacity to prepare one or more further cell candidates above and/or beyond and/or in addition to the requested amount. In examples, the requested amount can be/considered to be the maximum number of cell candidates indicated in the request 130.

In examples an indication 132 indicating a capacity to prepare one or more further cell candidates can be considered an additional capacity indication and/or an extra capacity indication and so on.

From the point of view of the access node 120, which in the example of FIG. 2 is the MN 164, block 206 illustrates receiving an indication 132 from at least one of the plurality of nodes indicating a capacity to prepare one or more further cell candidates.

In examples, receiving an indication 132 from at least one of the plurality of nodes indicating a capacity to prepare one or more further cell candidates can be considered receiving an indication 132 indicating a capacity of a node to prepare one or more further cell candidates above and/or beyond and/or in addition to the requested amount. In examples, the requested amount can be/considered to be the maximum number of cell candidates indicated in the request 130.

In examples, a node can prepare the requested number of cells, that in some examples is indicated in the request 130 for that node, prior to transmitting the indication 132.

Any suitable indication 132 having any suitable form to indicate a capacity to prepare one or more further cell candidates can be used.

In some examples, the indication 132 comprises at least one flag. For example, any suitable flag in any suitable message can be used.

In examples, any suitable flag indicating one or more cell candidates can be prepared can be used.

In some examples, the indication 132 comprises a value representing the number of cell candidates a node has the capacity to prepare above the requested number of cell candidates.

For example, the indication 132 can comprise a value representing the number of cells the node has the capacity to prepare above the indicated maximum number for that node.

In the example of FIG. 2, the indication 132 can comprise a flag indicating more target PSCells can be prepared and/or a value representing the number of target PSCells above the requested number that a target SN 166 node can prepare.

In some examples, the indication 132 comprises a list of the one or more cell candidates that can be prepared above the requested number of cell candidates. For example, the indication 132 can comprise a list of the one or more cell candidates that can be prepared above the indicated maximum number.

In examples, the list of one or more cell candidates, which can be target PSCells, can be considered a list of the one or more cell candidates that can be prepared above the indicated maximum number for a node.

Any suitable list of cell candidates having any suitable form can be used. For example, any suitable list having any suitable form can be used to allow an initiating node, such as the MN 164 in FIG. 2 or the source SN 166 in FIG. 3, to determine towards which nodes, if any, to send a further request 134 to prepare one or more further cell candidates.

In examples, the list of cell candidates can comprise any suitable information to allow such a determination to be made. See, for example, block 208.

In some examples, the list of cell candidates comprises a list of identifiers for the cell candidates that can be prepared above the requested number for a node, which in the example of FIG. 2 is a target SN 166 of the plurality of target SNs 166a-n. For example, the list of cell candidates can comprise a list of identifiers for the cell candidates that can be prepared above the maximum number indicated for a node.

Any suitable identifier or identifiers can be used. In some examples, the list of cell candidates comprises a list of cell IDs of the further cell candidates that can be prepared.

In some examples, the list of cell candidates comprises a corresponding measurement for the one or more cell candidates in the list. In some examples, not all cell candidates in the list have associated measurements.

Any suitable measurements in any suitable form can be included for at least one of the list of cell candidates. For example, the measurement can comprise one or more radio measurements, such as Reference Signal Received Power (RSRP), for the cell candidates in the list.

In some examples, such as SN initiated examples, the nodes, which are target SNs 166a-n in the example of FIG. 2, provide the list of candidate cells with a predefined corresponding measurement, for example RSRP, in a form that the MN 164 can understand, to enable the MN 164 to select the best next cell candidate(s), such as PSCell candidate(s), without consulting the initiating SN 166.

In some examples, such as MN initiated examples, the MN 164 can use the list of cell candidates to determine information to enable selection of the best next cell candidate(s). See block 208.

In examples, the list of cell candidates comprises an associated weight for the one or more cell candidates in the list, the associated weight indicating a comparison with one or more prepared cell candidates. In some examples, not all cell candidates in the list have associated weights.

In some examples, the associated weight is prepared in relation to the further cell candidates themselves, and not in relation to one or more prepared cell candidates.

Any suitable weight or weights can be used. For example, any suitable associated weight indicative of and/or representative of any suitable attribute or attributes of one or more of the cell candidates in the list can be used. Any suitable scale can be used for the associated weight or weights.

In examples, any suitable information can be used in determining the associated weight(s). For example, one or more of RSRP thresholds of the candidate cell, reported by the terminal node 110, current load of the candidate cell and/or compatibility of the terminal node's bearers/services/slices at the candidate cell and so on can be used.

In some examples, the associated weight(s) can be considered associated ranking(s).

In some examples, the associated weight provides an indication of how the cell candidates in the list compare and/or correspond to one or more of the cell candidates that have already been prepared and/or how the relevance of the cell candidate(s) in the list compared to the prepared candidate(s).

Accordingly, in examples, a node, such as a target SN 166, can prepare the maximum number of cell candidates, such as target PSCell candidates, which can be indicated for that node in the request 130 and can provide a list of additional cell candidates that can be prepared including associated weights providing a comparison and/or correspondence with one or more of the cell candidates that have already been prepared.

In examples where more than one candidate cell has been prepared, the weight can provide an indication of how the cell candidates in the list compare and/or correspond to one of the cell candidates that have been prepared, for example relative to the worst one of the prepared cell candidates.

The worst of the prepared cell candidates can be considered and/or determined in relation to any suitable attribute or attributes of the prepares cell candidates. For example, the worst of the prepared cell candidates can be in terms of one or more radio attributes, such as radio link quality and/or strength.

In examples, the associated weight provides an indication of one or more radio properties for the one or more cell candidates in the list and/or priority of the one or more cell candidates in the list.

The associated weight can provide an indication of any suitable radio property or properties. For example, the associated weight can provide an indication of radio link quality and/or strength of the candidate cells in the list.

In some examples, the associated weight can be considered to provide an indication of radio relevance of the candidate cells in the list.

For example, a weight of 1 can indicate that radio link quality and/or strength of a candidate cell in the list is similar to the worst of the prepared cell candidates, whereas a weight of 10 can indicate that the radio link quality and/or strength of a candidate cell in the list is much weaker than the worst prepared cell candidate.

In examples, any suitable numerical values for the weights can be used. For example, a low number can indicate weaker cell candidates and a higher number stronger cell candidates.

The associated weight can provide any suitable indication of priority of the one or more cell candidates in the list. In examples, a numerical weight for the candidate cells in the list can indicate the priority of the cells for preparation.

For example, the associated weight can indicate which of the cells in the list has the highest priority to be prepared.

For example, a weight of 1 can indicate that a candidate cell in the list has the highest priority to be prepared whereas a weight of 10 can indicate that a candidate cell has the lowest priority to be prepared.

In some examples, the indication 132 can be transmitted with a SgNB Addition Response message and/or a SgNB Addition Request Acknowledge message.

In examples, a confirmation of the prepared cell candidates can be transmitted. For example, a list of identifiers of the prepared cell candidates can also be transmitted to the MN 164.

In some examples, a limit can be set as to the overall maximum number of cell candidates, such as PSCell candidates, that can be prepared. For example, an overall maximum number of cell candidates configured at a terminal node 110, such as UE 204, can be set.

In examples, the overall maximum number of cell candidates to be prepared can be considered a global maximum and the maximum number for the nodes, such as target SNs 166a-n, in the request 130 a local maximum.

In some examples, a network node, such as the MN 164 or SN 166 (see, for example, FIG. 3) can amend a number of cell candidates to be prepared by at least one node based, at least in part, on the received indication 132 from at least one of the plurality of nodes indicating a capacity to prepare one or more further cell candidates.

For example, if the MN 164 in FIG. 2 receives indications 132 that there is capacity to prepare a number of further cell candidates the MN 164 can increase the, maximum number of cell candidates prepared by at least one node to make use of the capacity.

Accordingly, in examples, method 200 comprises amending a number of cell candidates to be prepared by at least one node based, at least in part, on the received indication 132 from at least one of the plurality of nodes indicating a capacity to prepare one or more further cell candidates.

In examples, the nodes from which an indication 132 is received can be considered responding nodes and/or additional capacity nodes and so on.

In some examples, block 205 and block 206 of FIG. can both occur in method 200, from different nodes.

At block 208, method 200 comprises determining, based at least in part on the indication 132, the one or more of the at least one of the plurality of nodes to which a further request 134 is to be transmitted.

In examples, this can be considered determining, based at least in part on the indication 132, the one or more of the at least one responding nodes to which a further request 134 is to be transmitted.

In some examples, such as SN initiated examples, method 200 comprises transmitting the indication 132 to a network node to enable a determination of the one or more of the at least one of the plurality of nodes to which the further request is to be transmitted.

That is, in some examples, block 208 is not performed by/at the MN 164. See, for example, FIG. 3.

Any suitable method can be used for determining, based at least in part on the indication 132, the one or more of the at least one of the plurality of nodes to which a further request 134 is to be transmitted.

For example, any suitable information in the indication 132 can be used in any suitable way in the determination.

In some examples, the determination can be based, at least in part, on the list(s) of cell candidates that can be prepared and any associated information and/or weights.

For example, measurements, such as RSRP, for the cell candidates in the list(s) of cell candidates can be compared to determine to which node(s) a further request 134 is to be transmitted.

In examples, the measurements for the cell candidates in the list(s) can be obtained from the terminal node 110 and/or included in the indication 132.

In examples, it can be determined to transmit a further request 134 to any suitable number of nodes, including zero nodes.

Additionally, or alternatively, block 208 can comprise determining, based at least in part on the indication 132, which cell candidates should be prepared.

In examples, any suitable information in the indication 132 can be used in any suitable way in determining which cell candidates should be prepared.

In some examples, the determination can be based, at least in part, on the list(s) of cell candidates that can be prepared and any associated information and/or weights.

For example, measurements, such as RSRP, for the cell candidates in the list(s) of cell candidates can be compared to determine which cell candidate(s), if any, should be prepared.

At block 210, method 200 comprises transmitting, to one or more of the at least one of the plurality of nodes, a further request 134 to prepare at least one further cell candidate.

Consequently, FIG. 2 illustrates a method 200 comprising: transmitting a request 130 to a plurality of nodes to prepare one or more cell candidates; receiving an indication 132 from at least one of the plurality of nodes indicating a capacity to prepare one or more further cell candidates; and transmitting, to one or more of the at least one of the plurality of nodes, a further request 134 to prepare at least one further cell candidate.

In examples, the further request 134 can be considered a request to prepare at least one cell candidate in addition to the cell candidates prepared based on and/or in response to the request 130.

In examples, the further request 134 can have any suitable form and/or be transmitted in any suitable way.

For example, the further request 134 can have any suitable form to request preparation of one or more cell candidates and can, in some examples, comprise any suitable indication of which cell candidate(s) should be prepared.

In examples, the further request 134 can comprise one or more cell IDs indicating which candidate cells should be prepared.

In examples, the further request 134 can be transmitted to different nodes and can indicate the same or a different number of further cell candidates to be prepared for different nodes.

In some examples, the further request 134 can have the same or similar form to request 130.

From the point of view of an access node 120, which in the example of FIG. 2 is a target SN 166, block 210 illustrates receiving a further request 134 to prepare at least one further cell candidate.

Consequently, FIG. 2 illustrates a method 200 comprising receiving a request 130 to prepare cell candidates; determining a capacity to prepare one or more further cell candidates; transmitting an indication 132 indicating a capacity to prepare one or more further cell candidates; and receiving a further request 134 to prepare at least one further cell candidate.

In examples, at block 212, the node(s) to which the further request 134 is transmitted prepare the further cell candidate(s) and, in some examples, confirm that the further cell candidate(s) have been prepared.

Any suitable confirmation transmitted in any suitable way can be used. For example, an SgNB Addition Response message and/or a SgNB Addition Request Acknowledge message can be transmitted to the MN 164.

Accordingly, in examples, method 200 comprises preparing at least one further cell candidate based, at least in part, on the received further request 134.

At block 214, the method 200 comprises transmitting a reconfiguration message 160 to a terminal node 110 when an overall maximum number of cell candidates has been prepared.

The terminal node 110 can be considered a user terminal and, in the example of FIG. 2, is a UE 204.

Any suitable reconfiguration message 160 can be used. For example, any suitable reconfiguration message 160 comprising information of the prepared cell candidates, such as target PSCells, can be used.

In examples the reconfiguration message 160 can be/comprise a Radio Resource Control (RRC) message or RRC messages.

In examples, the reconfiguration message 160 can be a conditional reconfiguration message for the prepared cell candidates.

For example, the reconfiguration message(s) can configure the terminal node 100 for CPC and/or CPA with respect to the prepared cell candidates, which in the illustrated example are target PSCell candidates.

In some examples, the reconfiguration message(s) 160 can be sent at any suitable point in the method 200. For example, the reconfiguration message(s) 160 can be sent prior to preparation of the further cell candidates.

In the example of FIG. 2, the reconfiguration message 160 can be transmitted after it is confirmed at block 206 that candidate cells have been prepared. See, for example, FIGS. 7 and 8.

In such examples, a further and/or additional reconfiguration message(s) 160 can be transmitted after further cell candidates have been prepared, to amend and/or update and/or change the configuration at the terminal node 110 to include cell candidates not included in the earlier reconfiguration message 160.

In some examples, one or more of the access nodes 120, which in the example of FIG. 2 are target SNs 166a-n, can prepare further and/or additional cell candidates above the requested number of cell candidates, based on the request 130, and inform the MN 164 that the further and/or additional candidate cells have been prepared.

For example, one or more of the access nodes 120 can prepare further and/or additional cell candidates above the indicated maximum value in the request 130.

The node(s) can request confirmation, prior to expiry of a timer 148, that one or more of the further and/or additional cell candidates should be maintained, otherwise the further and/or additional cell candidates can be released.

In examples, any suitable timer can be used. For example, a predetermined timer can be used, such as T304. In some examples, a timer value can be transmitted from the target SN 166 to the MN 164.

In examples, the indication 132 can be used to inform the MN 164 that further and/or additional cell candidates have been prepared and/or to request confirmation that the further and/or additional prepared cell candidates should be maintained and/or to provide a timer value.

In some examples, one or more different indications can be used.

Accordingly, from the point of view of the MN 164, in some examples method 200 comprises: receiving, from at least one of the plurality of nodes, an indication 132 that at least one additional cell candidate above the requested number of cell candidates has been prepared; and transmitting, to one or more of the at least one of the plurality of nodes from which an indication that at least one additional cell candidate has been prepared, a confirmation that one or more of the at least one additional cell candidate should be maintained, wherein the transmitting is prior to expiry of a timer.

In examples, any suitable confirmation having any suitable form and transmitted in any suitable way can be used.

In some examples, the confirmation can be transmitted in place of, or in addition to, or as at least part of the further request 134.

In examples, the further request 134 can be the confirmation.

In examples, node(s) from which an indication that at least one additional cell candidate has been prepared can be considered pre-prepared nodes and/or overprepared nodes and so on.

The MN 164 can include in the reconfiguration message 160 the confirmed additional cell candidates.

Otherwise, the MN 164 can send the reconfiguration message 160 without including the additional cell candidates prepared in this way, and without responding, and any additional cell candidates prepared in this way will be released.

With reference to FIG. 2, an indication 132 can be transmitted from one or more nodes at block 206, indicating that one or more cell candidates have been prepared above the requested number of cell candidates. For example, an indication 132 can be transmitted from one or more nodes indicating that one or more cell candidates have been prepared above the indicated maximum value in the request 130.

In such examples, at block 208 it is determined whether the additional cell candidates should be maintained and if it is determined that one or more of the additional cell candidates should be maintained a confirmation is transmitted to the appropriate node(s) prior to expiry of a timer 148.

A timer is illustrated in FIG. 2 by the double headed arrow labelled 148.

In some examples, the further request 134 can be considered a confirmation and in the illustrated example is transmitted prior to expiry of the timer 148, causing one or more additional cell candidates to be maintained.

From the point of view of an access node 120, which in the example of FIG. 2 is a target SN 166, method 200 can in some examples comprise: preparing at least one additional cell candidate above the requested number of cell candidates; transmitting an indication 132 that at least one additional cell candidate above the indicated requested number of cell candidates has been prepared; determining whether a confirmation that the at least one additional cell candidate should be maintained has been received prior to expiry of a timer 148; if it is determined that a confirmation has been received prior to expiry of the timer 148, maintaining the at least one additional cell candidate; and if it is determined that a confirmation has not been received prior to expiry of the timer 148, releasing the at least one additional cell candidate.

In examples, one or more of the blocks and/or actions of FIG. 2 can be omitted. For example, block 205 can be omitted.

Additionally, or alternatively, block 208 can be performed by a different node, and therefore be omitted from method 200. See, for example, FIG. 3.

Examples of the disclosure are advantageous. For example, examples of the disclosure provide for coordination of preparation of cell candidates, for example target PSCell candidates.

Examples of the disclosure ensure that a maximum amount of candidate cells permitted in a procedure, for example a CPC or CPA procedure, are prepared.

FIG. 3 illustrates an example of a method 300.

Method 300 of FIG. 3 is similar to method 200 of FIG. 2, and can similarly be considered to illustrate a plurality of different methods at individual actors/entities.

In the example FIG. 3, similarly to FIG. 2, a UE 204, MN 164 and a plurality of target SNs 166a-n are illustrated.

In examples, blocks of FIG. 3 can be as described in relation to the corresponding block of FIG. 2. For example, block 302 of FIG. 3 can be as described in relation to block 202 of FIG. 2, block 304 of FIG. 3 can be as described in relation to block 204 of FIG. 2 and so on.

However, the example of FIG. 3 is SN initiated and therefore access node 120 which is a source SN 166 is also illustrated.

At block 301, method 300 comprises transmitting an indication 168 indicating that an SN change should be made.

Any suitable indication 168 that an SN change should be made can be used.

In some examples, an SN Change Required message can be transmitted from the source SN 166 to the MN 164.

In examples, after block 301, the method can proceed as described in relation to method 200 of FIG. 2.

In such examples, the target SNs 166a-n can provide associated measurements with the indication 132 in a form that the MN 164 can understand so that the MN 164 does not have to consult the source SN 166, which is the initiating node in FIG. 3.

However, in the example of FIG. 3, block 308 (corresponding to block 208 of FIG. 2) is performed by/at the source SN 166.

Accordingly, at block 307 of FIG. 3, from the point of view of the MN 164, the method 300 comprises transmitting an indication 132 indicating a capacity for at least one node to prepare one or more further cell candidates.

The indication 132 can be as described in relation to FIG. 2. In some examples, the indication can be the same or similar or different to the indication(s) 132 received at the MN 164 in FIG. 2.

In examples, the indication 132 transmitted to the source SN 166 can be/comprise a composite of the indication(s) 132 received at the MN 164.

In some examples, the MN can add measurement values to the indication 132 prior to transmission to the source SN 166.

From the point of view of the source SN 166, method 300 comprises receiving an indication 132 indicating a capacity for at least one node to prepare one or more further cell candidates.

In examples, the indication 132 can be transmitted with any suitable message(s). In examples, a SgNB Change Confirm message can be used.

In the example illustrated in FIG. 3, block 308, corresponding to block 208 of FIG. 2, is performed by the source SN 166.

Accordingly, In the illustrated example, the source SN 166 determines based, at least in part, on the received indication 132, one or more nodes that are to be requested to prepare one or more further cell candidates.

At block 309, method 300 comprises transmitting one or more signals to cause the determined one or more nodes to prepare one or more cell candidates.

In examples, any suitable transmission(s) having any suitable form to cause one or more determined nodes to prepare one or more cell candidates can be used.

For example, one or more messages can be transmitted indicating one or more nodes that should prepare one or more further cell candidates and/or one or more cell candidates that should be prepared.

Consequently, FIG. 3 illustrates a method 300 comprising: receiving an indication 132 indicating a capacity for at least one node to prepare one or more further cell candidates; determining based, at least in part, on the received indication, one or more nodes that are to be requested to prepare one or more further cell candidates; and transmitting one or more signals to cause the determined one or more nodes to prepare one or more further cell candidates.

In examples, method 300 then proceeds as described in relation to FIG. 2.

FIG. 4 illustrates an example of a method 400.

In examples, the method 400 can be performed by any suitable apparatus comprising any suitable means for performing the method 400.

In examples, the method 400 is performed by an access node 120, such as MN 164.

At block 402, method 400 comprises transmitting a request 130 to a plurality of nodes to prepare one or more cell candidates.

At block 404, method 400 comprises receiving an indication 132 from at least one of the plurality of nodes indicating a capacity to prepare one or more further cell candidates.

At block 406, method 400 comprises transmitting, to one or more of the at least one of the plurality of nodes, a further request 134 to prepare at least one further cell candidate.

Consequently, FIG. 4 illustrates a method 400 comprising: Transmitting a request 130 to a plurality of nodes to prepare one or more cell candidates; receiving an indication 132 from at least one of the plurality of nodes indicating a capacity to prepare one or more further cell candidates; and transmitting, to one or more of the at least one of the plurality of nodes, a further request 134 to prepare at least one further cell candidate.

FIG. 5 illustrates an example of a method 500.

In examples, method 500 can be performed by any suitable apparatus comprising any suitable means for performing the method 500.

In examples, method 500 is performed by an access node, such as target SN 166.

At block 502, method 500 comprises receiving a request 130 to prepare one or more cell candidates.

At block 504, method 500 comprises determining a capacity to prepare one or more further cell candidates.

At block 506, method 500 comprises transmitting an indication 132 indicating a capacity to prepare one or more further cell candidates.

At block 508, method 500 comprises receiving a further request 134 to prepare at least one further cell candidate.

Consequently, FIG. 5 illustrates a method 500 comprising:
receiving a request 130 to prepare one or more cell candidates;
determining a capacity to prepare one or more further cell candidates;
transmitting an indication 132 indicating a capacity to prepare one or more further cell candidates; and
receiving a further request 134 to prepare at least one further cell candidate.

FIG. 6 illustrates an example of a method 600.

In examples, method 600 can be performed by any suitable apparatus comprising any suitable means for performing the method 600.

In examples, method 600 is performed by an access node 120, such as source access node 166.

At block 602, method 600 comprises receiving an indication 132 indicating a capacity for at least one node to prepare one or more further cell candidates.

At block 604, method 600 comprises determining, based at least in part, on the received indication 132, one or more nodes that are to be requested to prepare one or more further cell candidates.

At block 606, method 600 comprises transmitting one or more signals to cause the determined one or more nodes to prepare one or more further cell candidates.

Consequently, FIG. 6 illustrates a method 600 comprising:
receiving an indication 132 indicating a capacity for at least one node to prepare one or more further cell candidates;
determining based, at least in part, on the received indication, one or more nodes that are to be requested to prepare one or more further cell candidates; and
transmitting one or more signals to cause the determined one or more nodes to prepare one or more further cell candidates.

Some examples relate to 3GPP network. FIGS. 7 and 8 can be considered to illustrate some such examples.

The example of FIG. 7 is an example of conditional reconfiguration of a UE 204. In particular, the example of FIG. 7 is an example of a CPC procedure or CPA procedure.

In FIG. 7 a UE 204, MN 164, and target SN 166 communicate across a network, such as at least a portion of network 100 of FIG. 1.

In the example of FIG. 7 a source SN 166 is also present, and illustrated.

At block 702, a SgNB Addition Request message is transmitted from the MN 164 to a target SN 166. However, in examples, a SgNB Addition Request Message can be transmitted from the MN 164 to any suitable number of target SNs 166.

The SgNB Addition Request message comprises information about the maximum number of target PSCells that can be prepared. The information can be explicit or implicit. In examples, the SgNB Addition Request message can be considered a request 130 as described in relation to FIG. 2 and/or FIG. 3.

At block 704, the target SN 166 decides on the target PSCells, and prepares the requested number of target PSCells. For example, the target SN 166 can prepare the indicated maximum number of target PSCells.

At block 706, a SgNB Addition Request Acknowledge message is transmitted from the target SN 166 to the MN 164. In examples, a SgNB Addition Request Acknowledge message can be transmitted from any suitable number of target SNs 166 to the MN 164.

In the example of FIG. 7, the SgNB Addition Request Acknowledge message comprises a Cell ID list of the prepared target PSCells and information about the possibility to prepare more PSCells.

In examples, the information about the possibility to prepare more PSCells can be considered an indication 132 as described in relation to FIG. 2 and/or FIG. 3.

At block 708, a Conditional Reconfiguration message is transmitted from the MN 164 to the UE 204. The Conditional Reconfiguration message comprises RRC Reconfigurations of prepared target PSCells.

In examples, the Conditional Reconfiguration message can be considered a reconfiguration message 160 as described in relation to FIG. 2 and/or FIG. 3.

In examples, the MN 164 can determine based, at least in part, on the received information about the possibility to prepare more PSCells, to request the target SN 166 to prepare one or more additional PSCells if appropriate.

In some examples, the MN 164 can request a plurality of target SNs 166 to prepare one or more additional PSCells, if appropriate.

The example of FIG. 8 is an example of conditional reconfiguration of a UE 204. In particular, the example of FIG. 8 is an example of a CPC procedure or CPA procedure.

In FIG. 8 a UE 204, MN 164, a target SN 166 and a source SN 166 communicate across a network, such as at least a portion of network 100 of FIG. 1.

At block 802 a SN Change Required message is transmitted from the source SN 166 to the MN 164. The SN Change Required message comprises information about the maximum number of target PSCells that can be prepared. In examples, this can be and/or be considered to be a global or overall maximum number of target PSCells that can be prepared in the procedure.

At block 804, a SgNB Addition Request message is transmitted from the MN 164 to a target SN 166. However, in examples, a SgNB Addition Request Message can be transmitted from the MN 164 to any suitable number of target SNs 166.

The SgNB Addition Request message comprises information about the maximum number of target PSCells that can be prepared. The information can be explicit or implicit. In examples, the SgNB Addition Request message can be considered a request 130 as described in relation to FIG. 2 and/or FIG. 3.

At block 806, the target SN 166 decides on the target PSCells, and prepares the requested number of target PSCells.

At block 808, a SgNB Addition Response message is transmitted from the target SN 166 to the MN 164. In examples, a SgNB Addition Response message can be transmitted from any suitable number of target SNs 166 to the MN 164.

In the example of FIG. 8, the SgNB Addition Response message comprises a Cell ID list of the prepared target PSCells and information about the possibility to prepare more PSCells.

In examples, the information about the possibility to prepare more PSCells can be considered an indication 132 as described in relation to FIG. 2 and/or FIG. 3.

At block 810, a Conditional Reconfiguration message is transmitted from the MN 164 to the UE 204. The Conditional Reconfiguration message comprises RRC Reconfigurations of prepared target PSCells.

In examples, the Conditional Reconfiguration message can be considered a reconfiguration message 160 as described in relation to FIG. 2 and/or FIG. 3.

At block 812, a SgNB Change Confirm message is transmitted from the MN 164 to the source SN 166. The SgNB Change Confirm message comprises information about the possibility to prepare more PSCells.

In examples, the source SN 166 can determine based, at least in part, on the received information about the possibility to prepare more PSCells, to cause the MN 164 to request the target SN 166 to prepare one or more additional PSCells if appropriate.

In some examples, the source SN 166 can cause the MN 164 to request a plurality of target SNs 166 to prepare one or more additional PSCells if appropriate.

Examples of the disclosure are advantageous. For example, examples of the disclosure provide for an initiating node, such as a MN 164 or source SN 166 to coordinate preparation of cell candidates, for example target PSCell candidates.

In examples, such coordination can ensure that a maximum amount of candidate cells permitted in a procedure, for example a CPC or CPA procedure, are prepared to optimize cell candidate preparation.

FIG. 9A illustrates an example of a controller 1130. The controller 1130 can be used in an apparatus such as a network node 110, 120, such as a mobile terminal or UE and/or a gNB.

Implementation of a controller 1130 may be as controller circuitry. The controller 1130 may be implemented in hardware alone, have certain aspects in software including firmware alone or can be a combination of hardware and software (including firmware).

As illustrated in FIG. 9A the controller 1130 may be implemented using instructions that enable hardware functionality, for example, by using executable instructions of a computer program 1136 in a general-purpose or special-purpose processor 1132 that may be stored on a computer readable storage medium (disk, memory etc.) to be executed by such a processor 1132.

The processor 1132 is configured to read from and write to the memory 1134. The processor 1132 may also comprise an output interface via which data and/or commands are output by the processor 1132 and an input interface via which data and/or commands are input to the processor 1132.

The memory 1134 stores a computer program 1136 comprising computer program instructions (computer program code) that controls the operation of the apparatus when loaded into the processor 1132. The computer program instructions, of the computer program 1136, provide the logic and routines that enables the apparatus to perform the methods illustrated in FIGS. 2 and/or 3 and/or 4 and/or 5 and/or 6 and/or 7 and/or 8. The processor 1132 by reading the memory 1134 is able to load and execute the computer program 1136.

The apparatus therefore comprises:
at least one processor 1132; and
at least one memory 1134 including computer program code the at least one memory 1134 and the computer program code configured to, with the at least one processor 1132, cause the apparatus at least to perform:
transmitting a request to a plurality of nodes to prepare one or more cell candidates;
   receiving an indication from at least one of the plurality of nodes indicating a capacity to prepare one or more further cell candidates; and
   transmitting, to one or more of the at least one of the plurality of nodes, a further request to prepare at least one further cell candidate.

The apparatus therefore comprises:
at least one processor 1132; and
at least one memory 1134 including computer program code
the at least one memory 1134 and the computer program code configured to, with the at least one processor 1132, cause the apparatus at least to perform:
receiving a request to prepare one or more cell candidates;
   determining a capacity to prepare one or more further cell candidates;
   transmitting an indication indicating a capacity to prepare one or more further cell candidates; and
   receiving a further request to prepare at least one further cell candidate.

The apparatus therefore comprises:
at least one processor 1132; and
at least one memory 1134 including computer program code
the at least one memory 1134 and the computer program code configured to, with the at least one processor 1132, cause the apparatus at least to perform:
receive an indication indicating a capacity for at least one node to prepare one or more further cell candidates;
   determining based, at least in part, on the received indication, one or more nodes that are to be requested to prepare one or more further cell candidates; and
   transmitting one or more signals to cause the determined one or more nodes to prepare one or more further cell candidates.

As illustrated in FIG. 9A, the computer program 1136 may arrive at the apparatus via any suitable delivery mechanism 1162. The delivery mechanism 1162 may be, for example, a machine-readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1136. The delivery mechanism may be a signal configured to reliably transfer the computer program 1136. The apparatus may propagate or transmit the computer program 1136 as a computer data signal.

Computer program instructions for causing an apparatus to perform at least the following or for performing at least the following:
transmitting a request to a plurality of nodes to prepare one or more cell candidates;
   receiving an indication from at least one of the plurality of nodes indicating a capacity to prepare one or more further cell candidates; and
   transmitting, to one or more of the at least one of the plurality of nodes, a further request to prepare at least one further cell candidate.

Computer program instructions for causing an apparatus to perform at least the following or for performing at least the following:
receiving a request to prepare one or more cell candidates;
   determining a capacity to prepare one or more further cell candidates;
   transmitting an indication indicating a capacity to prepare one or more further cell candidates; and
   receiving a further request to prepare at least one further cell candidate.

Computer program instructions for causing an apparatus to perform at least the following or for performing at least the following:
receive an indication indicating a capacity for at least one node to prepare one or more further cell candidates;
   determining based, at least in part, on the received indication, one or more nodes that are to be requested to prepare one or more further cell candidates; and
   transmitting one or more signals to cause the determined one or more nodes to prepare one or more further cell candidates.

The computer program instructions may be comprised in a computer program, a non-transitory computer readable medium, a computer program product, a machine-readable medium. In some but not necessarily all examples, the computer program instructions may be distributed over more than one computer program.

Although the memory 1134 is illustrated as a single component/circuitry it may be implemented as one or more separate components/circuitry some or all of which may be integrated/removable and/or may provide permanent/semi-permanent/dynamic/cached storage.

In examples the memory 1134 comprises a random-access memory 1158 and a read only memory 1160. In examples the computer program 1136 can be stored in the read only memory 1158. See, for example, FIG. 9B In some examples the memory 1134 can be split into random access memory 1158 and read only memory 1160.

Although the processor 1132 is illustrated as a single component/circuitry it may be implemented as one or more separate components/circuitry some or all of which may be integrated/removable. The processor 1132 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and/or 3 and/or 4 and/or 5 and/or 6 and/or 7 and/or 8 may represent steps in a method and/or sections of code in the computer program 1136. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus can, in examples, comprise means for:
transmitting a request to a plurality of nodes to prepare one or more cell candidates;
   receiving an indication from at least one of the plurality of nodes indicating a capacity to prepare one or more further cell candidates; and
   transmitting, to one or more of the at least one of the plurality of nodes, a further request to prepare at least one further cell candidate.

Thus, the apparatus can, in examples, comprise means for:
receiving a request to prepare one or more cell candidates;
   determining a capacity to prepare one or more further cell candidates;
   transmitting an indication indicating a capacity to prepare one or more further cell candidates; and
   receiving a further request to prepare at least one further cell candidate.

Thus, the apparatus can, in examples, comprise means for:
receiving an indication indicating a capacity for at least one node to prepare one or more further cell candidates;
   determining based, at least in part, on the received indication, one or more nodes that are to be requested to prepare one or more further cell candidates; and
   transmitting one or more signals to cause the determined one or more nodes to prepare one or more further cell candidates.

In examples, an apparatus can comprise means for performing one or more methods, or at least part of one or more methods, as disclosed herein.

In examples, an apparatus can be configured to perform one or more methods, or at least part of one or more methods, as disclosed herein.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance, it should be understood that the Applicant may seek protection via the claims in respect of any patentable feature or combination of features hereinbefore referred to and/or shown in the drawings whether or not emphasis has been placed thereon.

I/We claim:

1. A network node comprising
at least one processor; and
at least one memory including computer program code;
the at least one memory and the computer program code configured to, with the at least one processor, cause the network node at least to perform:
transmitting a request to a plurality of nodes to prepare one or more cell candidates;
receiving an indication from at least one of the plurality of nodes indicating a capacity to prepare one or more further cell candidates; and
transmitting, to one or more of the at least one of the plurality of nodes, a further request to prepare at least one further cell candidate.

2. A network node as claimed in claim 1, wherein the request indicates a maximum number of cell candidates.

3. A network node as claimed in claim 1, wherein the indication comprises at least one flag.

4. A network node as claimed in claim 1, wherein the indication comprises a value representing the number of cell candidates a node has the capacity to prepare above the requested number of cell candidates.

5. A network node as claimed in claim 1, wherein the indication comprises a list of the one or more cell candidates that can be prepared above the requested number of cell candidates.

6. A network node as claimed in claim 1, the at least one memory and the computer program code configured to, with the at least one processor, cause the network node at least to perform:
determining, based at least in part on the indication, the one or more of the at least one of the plurality of nodes to which the further request is to be transmitted; and/or
transmitting the indication to a network node to enable a determination of the one or more of the at least one of the plurality of nodes to which the further request is to be transmitted.

7. A network node as claimed in claim 5, wherein the list of cell candidates comprises a corresponding measurement for the one or more cell candidates in the list.

8. A network node as claimed in claim 5, wherein the list of cell candidates comprises an associated weight for the one or more cell candidates in the list, the associated weight indicating a comparison with one or more prepared cell candidates.

9. A network node as claimed in claim 8, wherein the associated weight provides an indication of one or more radio properties for the one or more cell candidates in the list and/or priority of the one or more cell candidates in the list.

10. A network node as claimed in claim 1, the at least one memory and the computer program code configured to, with the at least one processor, cause the network node at least to perform:
receiving, from at least one of the plurality of nodes, an indication that at least one additional cell candidate above the requested number of cell candidates has been prepared; and
transmitting, to one or more of the at least one of the plurality of nodes from which an indication that at least one additional cell candidate has been prepared, a confirmation that one or more of the at least one additional cell candidate should be maintained, wherein the transmitting is prior to expiry of a timer.

11. A network node as claimed in claim 1, the at least one memory and the computer program code configured to, with the at least one processor, cause the network node at least to perform:
receiving an indication from at least one of the plurality of nodes indicating that the requested number of cell candidates cannot be prepared.

12. A network node as claimed in claim 1, the at least one memory and the computer program code configured to, with the at least one processor, cause the network node at least to perform:
amending a number of cell candidates to be prepared by at least one node based, at least in part, on the received indication from at least one of the plurality of nodes indicating a capacity to prepare one or more further cell candidates.

13. A network node as claimed in claim 1, the at least one memory and the computer program code configured to, with the at least one processor, cause the network node at least to perform:
transmitting a reconfiguration message to a terminal node when an overall maximum number of cell candidates has been prepared.

14-20. (canceled)

21. A network node comprising
at least one processor; and
at least one memory including computer program code;
the at least one memory and the computer program code configured to, with the at least one processor, cause the network node at least to perform:
receiving a request to prepare one or more cell candidates;
determining a capacity to prepare one or more further cell candidates;
transmitting an indication indicating a capacity to prepare one or more further cell candidates; and
receiving a further request to prepare at least one further cell candidate.

22. A network node as claimed in claim 21, wherein the request indicates a maximum number of cell candidates.

23. A network node as claimed in claim 21, the at least one memory and computer program code configured to, with the at least on processor, cause the network node at least to perform: preparing at least one further cell candidate based, at least in part, on the received further request.

24. A network node as claimed in claim 21, the at least one memory and computer program code configured to, with the at least one processor, cause the network node at least to perform:
preparing at least one additional cell candidate above the requested number of cell candidates;
transmitting an indication that at least one additional cell candidate above the requested number of cell candidates has been prepared;
determining whether a confirmation that the at least one additional cell candidate should be maintained has been received prior to expiry of a timer;
if it is determined that a confirmation has been received prior to expiry of the timer, maintaining the at least one additional cell candidate; and
if it is determined that a confirmation has not been received prior to expiry of the timer, releasing the at least one additional cell candidate.

25. A network node comprising
at least one processor; and
at least one memory including computer program code;
the at least one memory and the computer program code configured to, with the at least one processor, cause the network node at least to perform:
receiving an indication indicating a capacity for at least one node to prepare one or more further cell candidates;
determining based, at least in part, on the received indication, one or more nodes that are to be requested to prepare one or more further cell candidates; and
transmitting one or more signals to cause the determined one or more nodes to prepare one or more further cell candidates.
